(19) United States
(12) Patent Application Publication
(10) Pub. No.: US 2009/0320101 A1
(43) Pub. Date: Dec. 24, 2009

(54) SYSTEM AND METHOD FOR AUTHENTICATING USERS IN A SOCIAL NETWORK

(76) Inventors: Richard Proctor Doyle, III, Lafayette, CA (US); Paul Eric Loeb, Los Angeles, CA (US)

Correspondence Address: Richard Proctor Doyle III, Suite 220, 2540 Camino Diablo, Walnut Creek, CA, 94597, US

(21) Appl. No.: 12/141,896

(22) Filed: Jun. 18, 2008

(51) Int. Cl. H04L 9/32

(52) U.S. Cl. 726/4

(57) ABSTRACT

A system and method is provided that authenticates the identity of the person behind a username and stores that information in a manner that allows a first person communicating on a social network with a second person to confirm that the identity of the second person is known and authenticate without requiring the second person to reveal identity information (other than their user name/screen name) to the first person and vice versa.

### FIELD OF THE INVENTION

The present invention generally relates to social networking on the Internet, and more particularly to allowing a user in a social network to authenticate another user without revealing to the user identity information of the other user.

### BACKGROUND OF THE INVENTION

Today, telephone calls with caller ID provide confidence that the telephone call is coming from the displayed phone number, because your phone service provider has authenticated the caller's identity. But there is no established means to authenticate the identity of someone who contacts you through the Internet. With the prevalence of social networking websites, over 160 million people are registered on just the five most popular sites. Due to the total anonymity of the Internet, this is a serious problem for all users of the Internet; there are unlimited opportunities for predators to impersonate someone. It is especially an issue for children under the age of 18.

The safety of children on the Internet is a serious personal concern for parents. The issue has attracted the attention of legislators as well. In fact, many states are considering legislation that will compel social networks to assure the identity and age of those claiming to be under the age of 18, in order to protect children. Social networking sites are trying to cope with these concerns, fearing the creation of prohibitive barriers to users wishing to enter their sites.

However, the anonymity is a significant driver for Internet use. As a result, social networking sites are resistant to any solution that reveals the identity of its users or in any way jeopardizes the anonymity. Such solutions would cause the loss of users and thus the loss of revenues.

### SUMMARY OF THE INVENTION

The present invention authenticates the identity of the person behind a username and stores that information in a manner that allows a first person communicating on a social network with a second person to confirm that the identity of the second person is known and authenticated without requiring the second person to reveal identity information (other than their user name/screen name) to the first person and vice versa.

When applied to children, the present invention confirms the identity of children through a trusted adult. This allows children to remain anonymous on the Internet while social networking and the person they are talking with cannot learn their identity.

When applied to adults, the system of the present invention allows adults to meet other people knowing that the person they are chatting with is a real person whose identity has been authenticated.

It is a goal of the present invention to discourage those with illicit purposes from using social networking sites by authenticating and storing the identity of persons using the social networking site.

In one aspect of the present invention these goals are carried out by authenticating the identity of a person on a social network operating on the Internet by obtaining identity information of a first person over a predetermined age; comparing the identify information to information at a trusted identification server to authenticate the identity of the first person; if authenticated, storing the identity information in a first database; receiving from the first person at least one social network online identifier (e.g., user name, screen name or e-mail address) and associated social network of a second person under a predetermined age; storing the online identifier and associated social network in a second database; receiving a request to verify the identity of a submitted online identifier; determining if the submitted online identifier is stored in the second database; and if the submitted online identifier is stored in the second database, transmitting to the first person a message confirming that the identity information of the second person associated with the submitted online identifier has been authenticated.

In another aspect, the present invention provides the identity information of the second person to law enforcement in the event there is a safety concern involving the second person.

In a further aspect of the present invention, a widget is added to an authenticated person's social network page to allow other persons to authenticate the authenticated person.

### BRIEF DECSRIPTION OF THE DRAWINGS

FIG. 1 depicts a block diagram of the system of the present invention.

FIG. 2 depicts a block diagram of the registration and authentication process of the present invention.

FIG. 3 depicts the home page of the system of the present invention.

FIG. 4 depicts a web page of the system of the present invention indicating that a username is authenticated.

FIG. 5 depicts a web page of the system of the present invention indicating that a username is not authenticated.

FIG. 6 depicts a web page of the system of the present invention for subscribers to login to the system.

FIG. 7 depicts a web page of the system of the present invention for registration of users.

FIG. 8 depicts a web page of the system of the present invention for registration of users.

FIGS. 9A -C depict a web page of the system of the present invention for registration of users.

FIG. 10 depicts a web page of the system of the present invention for registration of users.

FIG. 11 depicts an integration of the present invention into a social networking website; in this case as a Facebook application.

FIG. 12 depicts a Facebook profile with the integration of the present invention.

FIG. 13 depicts a Facebook page showing the authentication result of the present invention.

### DETAILED DESCRIPTION OF THE PREFERRED EMBODIMENTS

### Overview

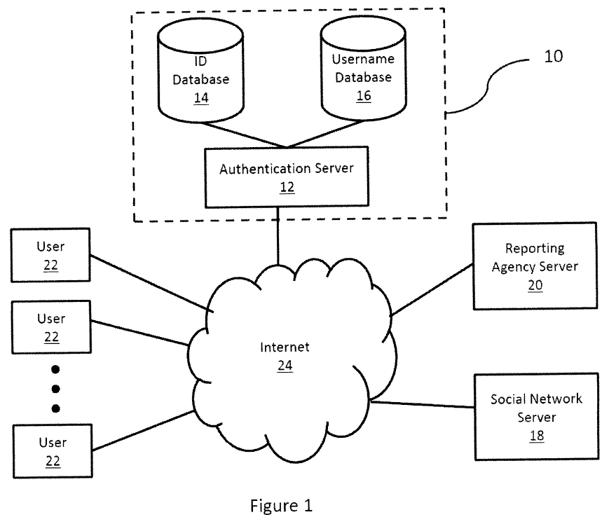

System 10 of the preferred embodiment of the present invention, as depicted in FIG. 1, includes authentication server 12, identity information database 14, and username database 16. System 10 interacts and is in communication with social network server 18 (e.g., Facebook, MySpace and other social networking servers), reporting agency server 20 and user computers 22 (each associated with a person using a social network), via Internet 24.

When social networking on the Internet, people generally identify themselves by a screen identifier or name (e.g., JoeUser5) that provides anonymity and does not reveal any identity information. System 10 connects a person's screen identifier with their actual identity, without compromising their privacy.

System 10 enables a user (or if a child, the users parent or guardian) to authentic a new person with which the user want to chat or interact on a social network is who they represent themselves to be (e.g., another child). While the actual identity (name, birth date, social security number, and other identity information) is known to system 10 and securely stored, the user is unable to retrieve the identity information of the new person. If the new person is known to system 10 as an authentic member, the user is advised the new person has been authenticated. If not, the user is advised that they are at risk. System 10 securely stores members' identities and only provides that information to law enforcement agencies upon an official request.

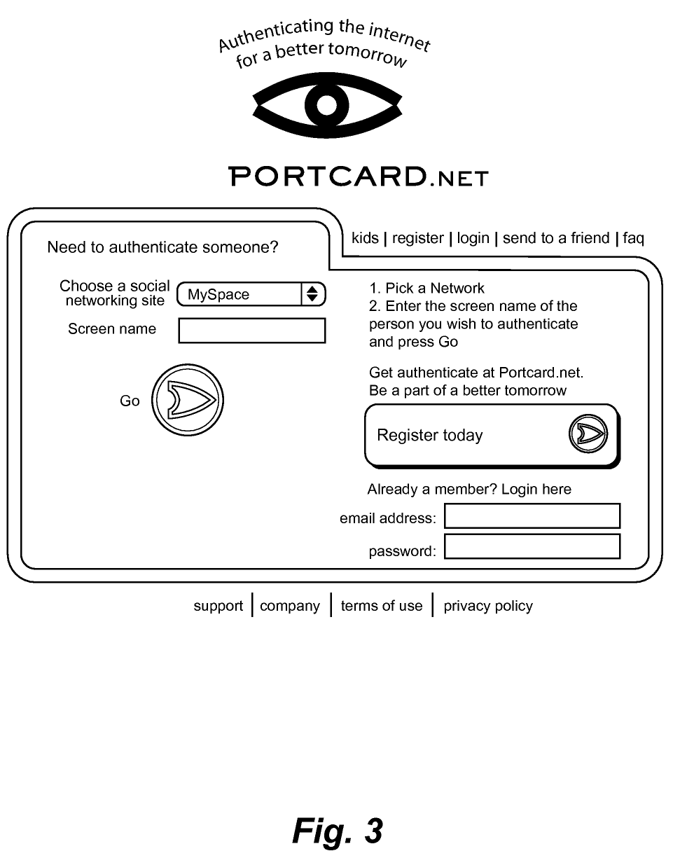

Users may utilize the system through a series of web pages as depicted in FIGS. 3-12. The first web page encountered is the system home page as depicted in FIG. 3, which allows a person to enter the username of another person to determine whether the other person has been authenticated by system 10.

When you chat with someone who has been “carded” by system 10, you can be confident that his or her identity has been authenticated by system 10; and that their identity information is securely stored, just as when the caller ID comes up on your phone.

For children under 18, system 10 requires registration by a parent or guardian. If any username on an account is entered at system 10 by someone seeking to confirm authentication of that user, a notification will be sent to the registered person. This allows the person who registered with system 10 on the child's behalf, usually a parent, to be notified when someone “cards” their child's registered username at system 10.

The idea of registration, especially a paid registration, has traditionally had a chilling effect on the business model of social networking sites. This is because the business model of social networking sites is driven by user volume. System 10 solves this dilemma by being a cross platform solution that permits the social networking sites to offer, but not require, registration to those seeking the safeguards that it offers.

Even more compelling, social networking sites do not need to build out the infrastructure by which users would have to register at each individual social networking site; yet the social networking sites will benefit financially and otherwise from partnering with system 10. Specifically, the social networking sites will receive a referral fee for having forwarded users to system 10 for registration, and the sites will further benefit from the peace of mind offered to registrants and their parents which will open the Internet of millions of children whose parents currently do not allow them to visit social networking sites.

Thus, by partnering with system 10, the social networking sites will avoid a registration process that might otherwise act as a barrier to entry; increase traffic to the site as parents feel safer about their children's participation; generate a new income stream; and improve the safety of the Internet.

Being “carded” by system 10 and limiting a person's social networking to others who also have been “carded” at system 10 will remove the total anonymity that predators are so readily exploiting today. This should dramatically reduce the risk of children under the age of 18 being taken advantage of; and it should give parents comfort in knowing that their child has the ability, which will become the child's obligation, to “card” the people they are communicating with on these highly popular social networks.

The present invention is also applicable beyond social networking sites to authenticating all users on the Internet. Other sites may interact with the components of system 10 in the same manner as social network server 14.

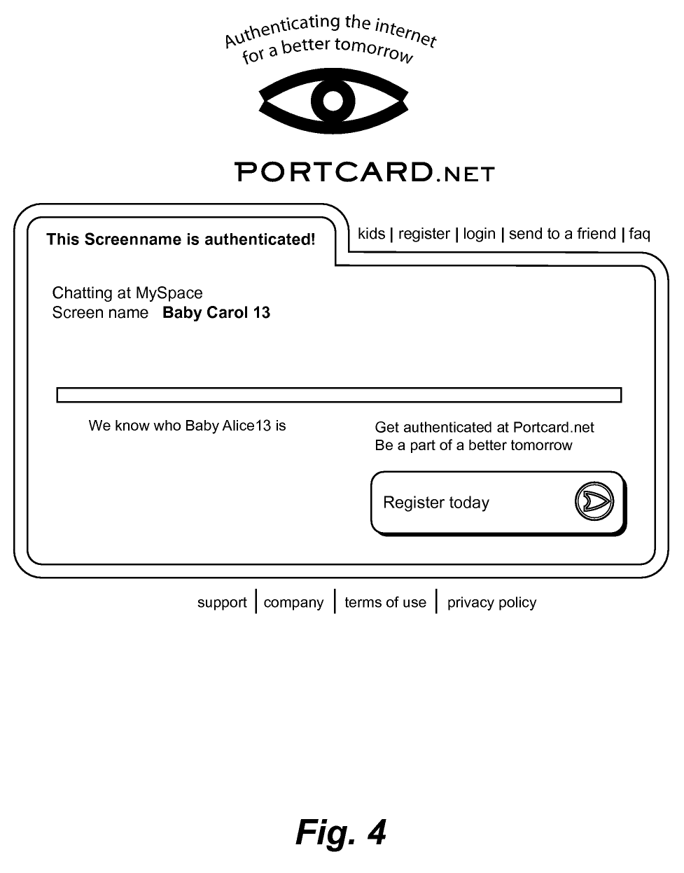

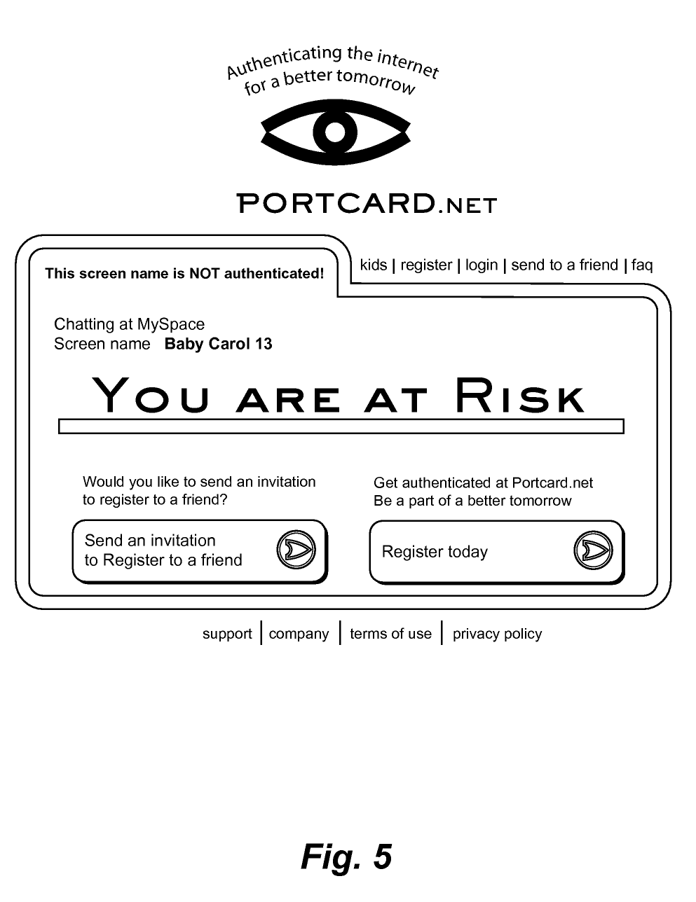

FIG. 4 depicts the web page a person will see if a username has been authenticated by system 10. FIG. 5 depicts the page a person will see if a username they “card” has not been authenticated.

Registration places parents into a position of involvement and responsibility as to with whom their children are chatting. Registration also allows the social networking sites to place the government in a position of involvement and responsibility. This is done as the names and screen names of children will be required at the time of registration if those children have usernames they want authenticated by system 10. This information will be available for cross-checking by governmental entities.

Social networking sites benefit from system 10. First, social networking sites have traditionally not wanted to require registration because their users leave and go to less-restrictive sites. The system, as a third party, provides registration for all Internet users regardless of the sites being visited. This way, all social networking sites remain on a level playing field as to the requirements of registration. All social networking sites can send their users to register at system 10, and prevent a mass exodus from one particular site to another based on differing registration requirements and costs.

Working with system 10 allows the social networking sites to stop being the only party responsible to monitor, register and protect persons who are social networking. They are not doing the job, and they do not have the tools to do so. The system's unique registration system gives parents some control, but also places new responsibility on parents. Simultaneously, our system presents a way to utilize both governmental agencies and privately collected credit data to protect children. No one else offers this sort of multiple resource protection.

Second, system 10 has a unique way of obtaining sponsorship approval from social networking sites such as MySpace and Facebook. The system's business model is to charge a registration fee, which will re-occur on a yearly basis, and system 10 will give a fee back to the site that directs that person to register with system 10.

Database 14 utilized by system 10 contains only enough personal information to confirm personal identities and not more. Such a database is realistic, as it includes information most people regularly provide to other business sites. When a user provides such identity information, credit-reporting agencies, including Experian, TransUnion, and Equifax, have the ability to check to confirm identity. These companies have a database of social securities, driver's license numbers, and credit information. System 10 partners with third party to confirm personal identities via reporting agency server 20.

Authentication server 12 requires a registered subscriber to include a full name and address to confirm the billing information to a credit card or PayPal, as well as the name, age and social security number of the child who will be chatting on the Internet. This information is then sent to one reporting agency server 20 and checked for congruency. If the social security number and the name given by the subscriber match, then the parent can then register children so that the system database will have information as to the age range of someone under 18. The usernames and associated social networking sites of the child is stored in that subscriber will be registered for their usernames. System 10 stores all of the identity information in database 14 and the usernames in database 16. Preferably, physically separate databases to insulate identity information from potential security breaches.

System 10 stores the user's verified identity information in database 14, in the event there is a need to identify a particular registered user to law enforcement. Identity information is securely stored and made available to law enforcement or other governmental officials, in response to a verified request relating to a criminal investigation or alleged illegal activity in the event there is an issue, problem or need to learn identity information to protect another person's rights, property, or safety. Users cannot learn the identity of the person they are talking with through system 10.

When a person chats only with someone who has been “carded” by system 10, they can be confident that the identity of the person with which they are chatting has been authenticated by system 10, and that identity is securely stored, just as when the caller ID comes up on their phone.

System 10 does not identify predators or prevent people from talking to a predator. System 10 provides a personal information database. Being “carded” at system 10, and limiting social networking to others who also have been “carded” at system 10, removes the total anonymity that predators are so readily exploiting today. This should dramatically reduce the risk of children under the age of 18 being taken advantage of, and it should give parents comfort in knowing that their child has the ability, and obligation, to “card” the people they are communicating with on these highly popular social networks.

For an adult, the information they currently provide for billing and verification is the information required for registration. For children, it is the information they provide to schools, doctors, dentists, etc., including the child's name, birth date and social security number. Identity information is not collected (such as school information) that could identify a child separate and apart from the parent's information.

System 10 verifies the information provided as to the registrant based on the latest in industry-accepted techniques for catching those perpetrating identity theft. System 10 will not register any person whose information does not meet this review process. If an adult is not registered, they cannot register their children.

### System Structure

Authentication server 12 is built on a Microsoft ASP.Net 2.0 platform and utilizes the Atlas module for AJAX (Asynchronous JavaScript and XML) compilation. AJAX is a key element of the new Web 2.0 infrastructure, which provides a user experience that is more interactive and richer than anything previously available.

Preferably, reporting agency server 20 runs on the .Net platform as well. In particular, identity verification software on reporting agency server 20 should be written in VB.NET for business logic using SQL Server and direct socket connections to their databases for data storage and retrieval. Authentication server 12 communicates with reporting agency server 20 through secure .Net Web Services.

Authentication server 12 is hosted on Windows Server 2003 running Microsoft Internet Information Services (a web server built in to Windows). Being integrated with the operating system allows for system-level security, authentication, and firewall protection.

As for security, authentication server 12 handles payment processing off-site (e.g., PayPal). Registration, during which identity information is provided, is encrypted utilizing industry standard encryption schemes on the .Net platform, in conjunction with Microsoft SQL Server.

System 10 is secured with SSL (Secure Sockets Layer) technology. SSL is a cryptographic system to transmit secure data over the Internet. It provides an extra buffer of security to protect against hackers stealing data between one computer and another. When SSL is in use by a website, the address begins with https://. This is typically used for online credit card transactions. The offsite payment system 26, preferably PayPal, uses SSL, so the interface is secure. In addition, reporting agency server 20 uses .Net Web Services over HTTPS for integration, to provide a secure connection.

The web pages served by authentication server 12 have an SSL certificate installed. Users may validate the SSL certificate by clicking on the icon of a secure lock at the bottom of their browser. This will give them more assurance and peace of mind that their data is safe and in good hands. The certificate is contracted for from a third party such as VeriSign.

Authentication server 12 also interacts with social networking servers 18, so that there is link as part of the registration process (explained in detail below) of system 10. When a person is linked from their user computer 22 to their social networking page on social network server 18 by providing their identity information to social network server 18 their identity information is automatically transferred to the registration process of system 10.

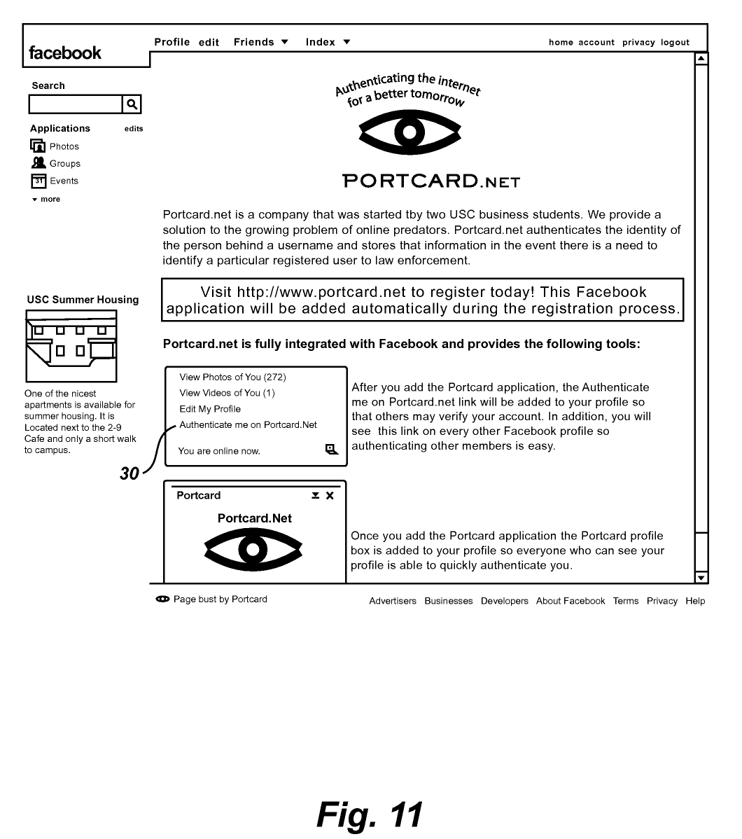

As shown in FIG. 11, the access to system 10 from Facebook. The user is on a facebook.com site which contains an iframe displaying a page from authentication server 12. This page is informational and explains the features of integrating system 10 with a user's Facebook profile and includes a link 30 to the registration service on authentication server 12.

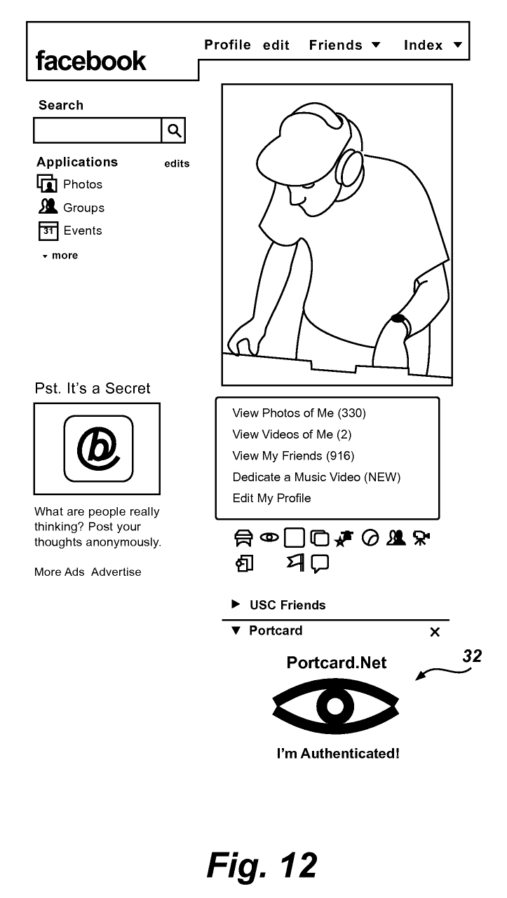

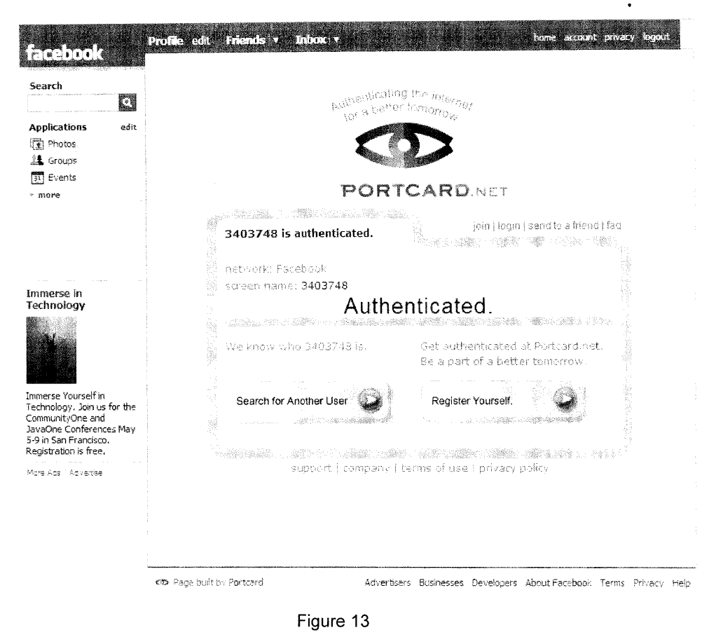

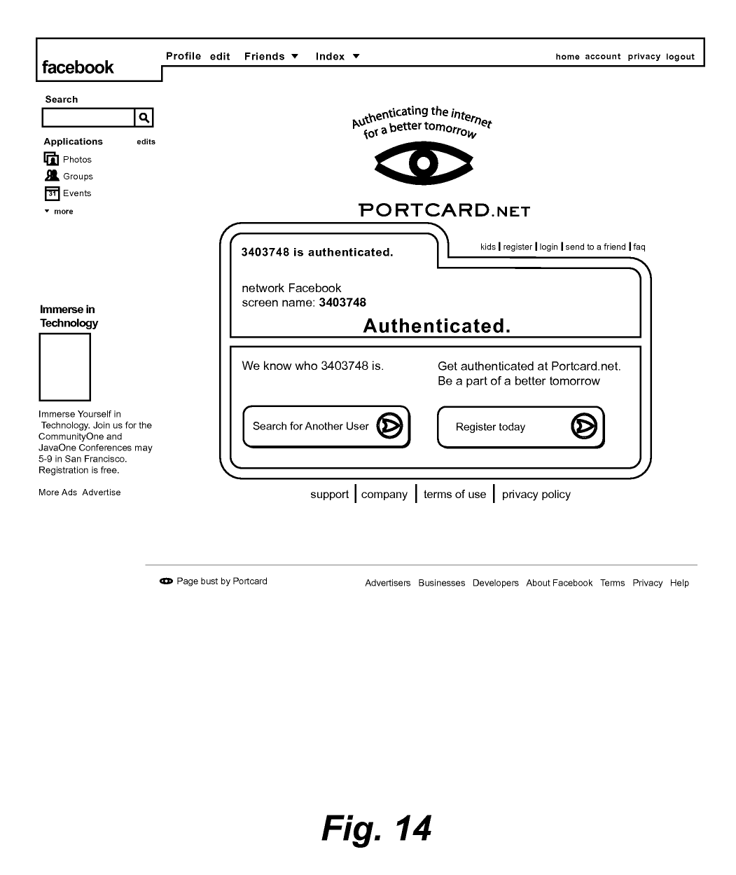

As shown in FIG. 12, system 10 is integrated into a user's Facebook profile page. This page is generated from a Facebook server, without any connection to authentication server 12. This page shows a button 32 in the form of an image (containing “Portcard.net”, the logo, “I'm Authenticated”) that contains a hyperlink to the authentication service on authentication server 12; the results of which are displayed in FIG. 13.

FIG. 13 shows the outcome of clicking the aforementioned button in FIG. 12. One of two results will be displayed, depending on the authentication status of the Facebook user in question. Here, the screen shows “Authenticated” (on a page generated by Facebook with a connection to authentication server 12). The alternative result would be “You are at risk”.

### System Processes

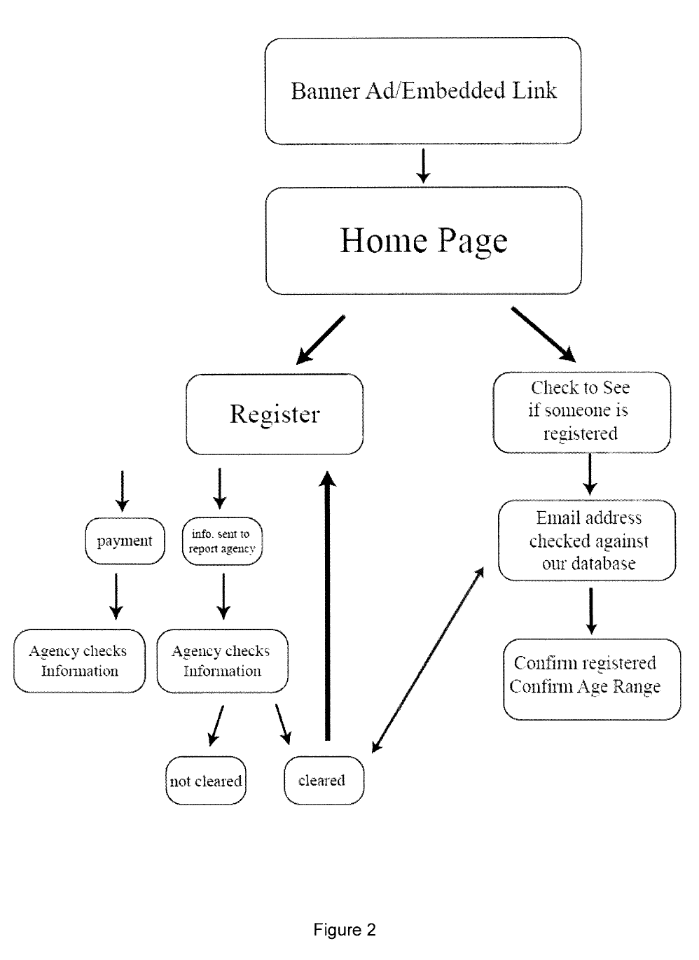

Users interact with system 10 through the web pages of authentication server 12, which are configured to carry out three main processes: search/verification, registration, and login. The flow of a user navigating through the web pages of authentication server 12 is depicted in FIG. 2. The particular web pages served to a user computer 22 are depicted in FIGS. 3 to 10.

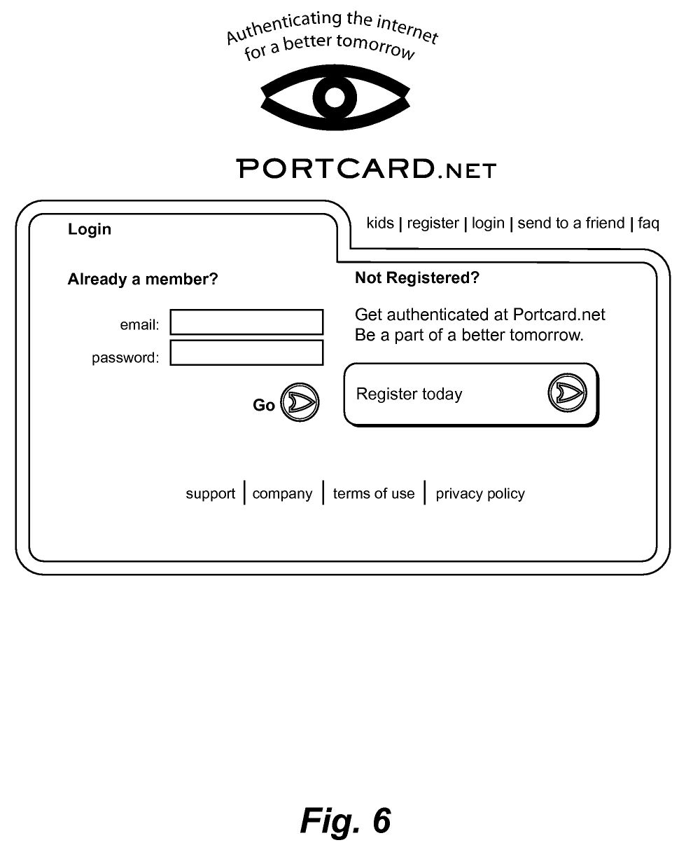

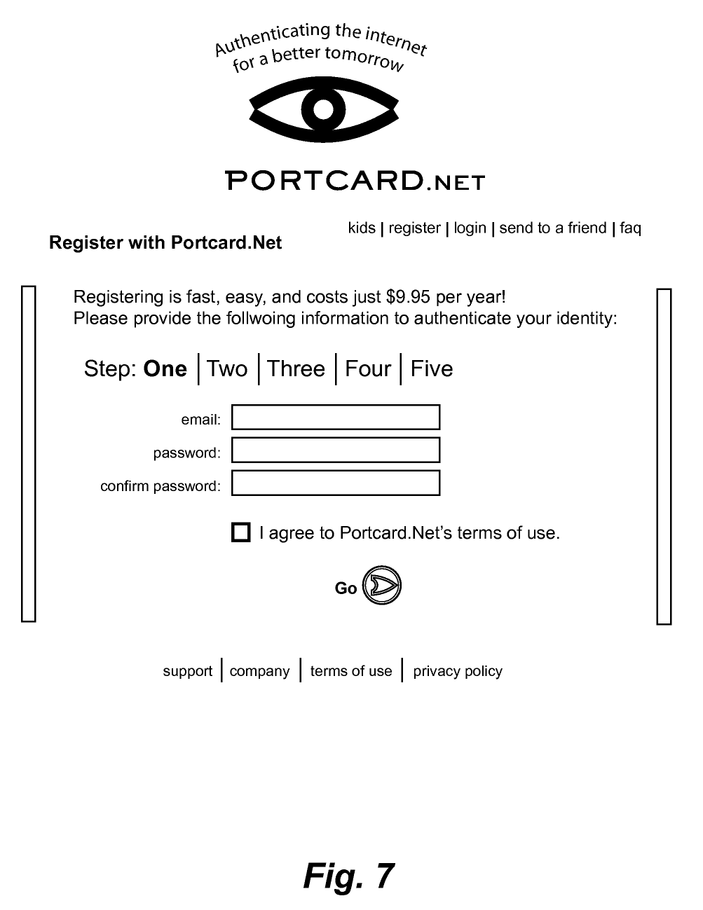

In the search/verification process, via the web page depicted in FIG. 3, a person requests authentication server 12 to authenticate another person based upon the other person's online identity and associated social network. In the registration process, via the registration web pages depicted in FIGS. 7-10, a person may register with authentication server 12 so that the person's identity becomes known to system 10. This enables others to verify that the person has been authenticated (i.e., known to system 10). In the login process, via the web page depicted in FIG. 6, an authenticated person may login to their account on authentication server 12 to update their account information, renew their subscription and check their authentication statistics.

The search process includes two steps. First, picking a social network, such as MySpace, Facebook, or AdultFriendFinder. Second, entering the identification (such as username, screen name, email address, or other online identity) of the user to be authenticated. System 10 responds that either the user is verified as shown in FIG. 4 and pings the authenticated user that was just verified, or the user is not verified as depicted in FIG. 5 and allows the person requesting verification to send a message to the user that is not authenticated inviting them to register with system 10.

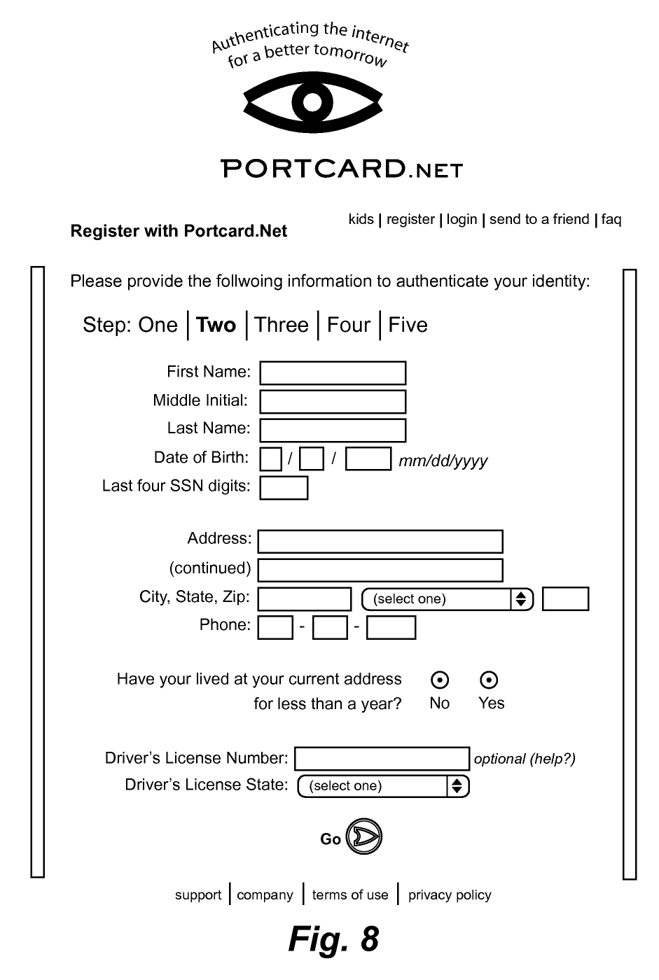

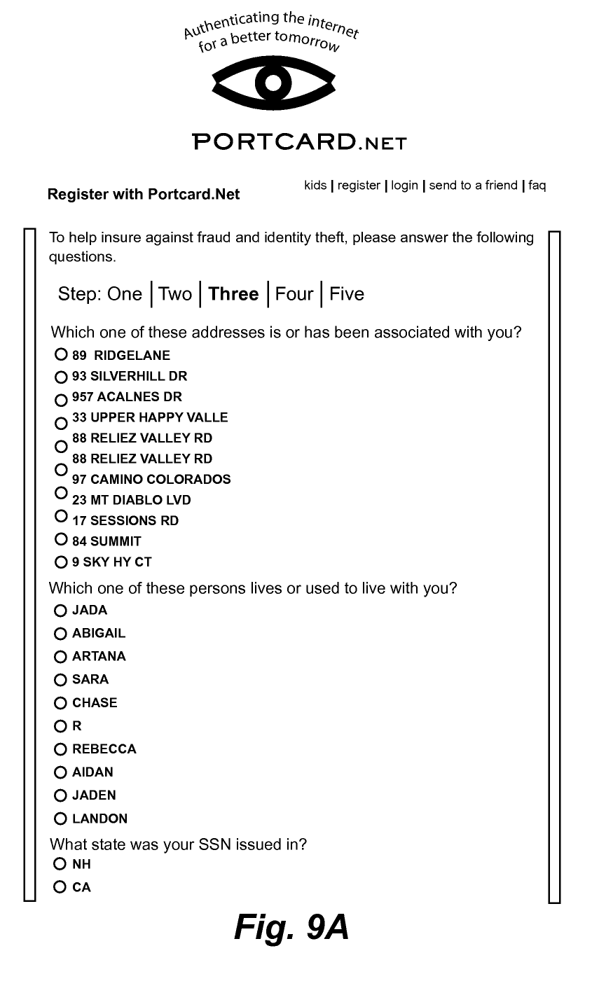

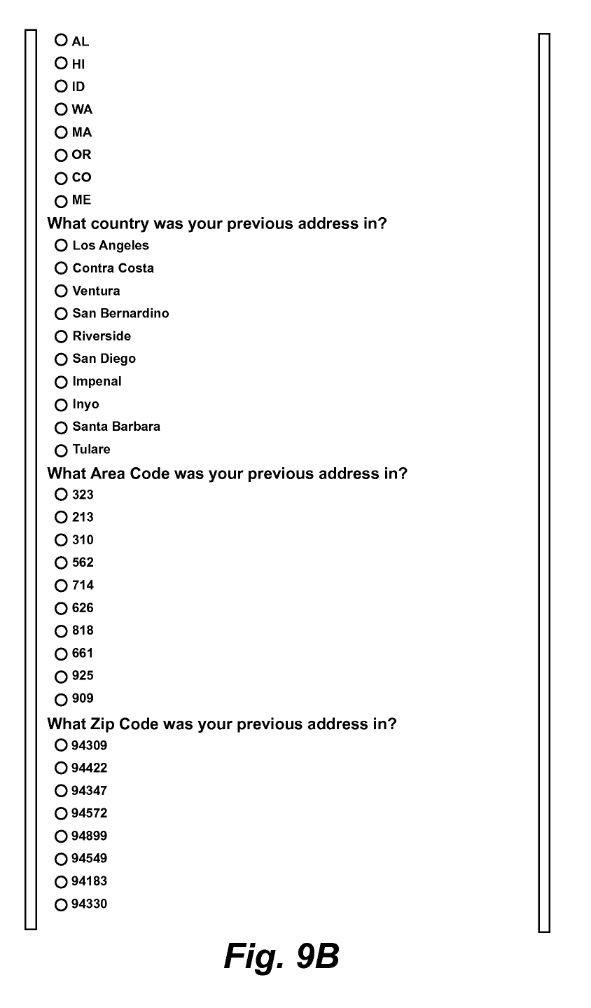

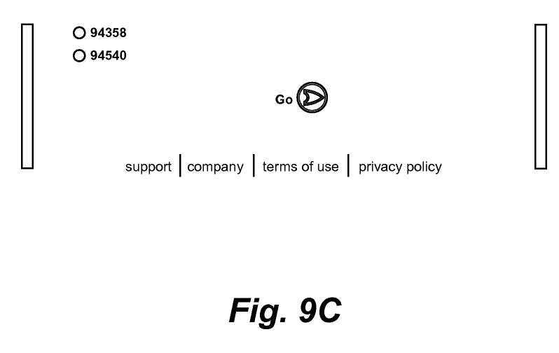

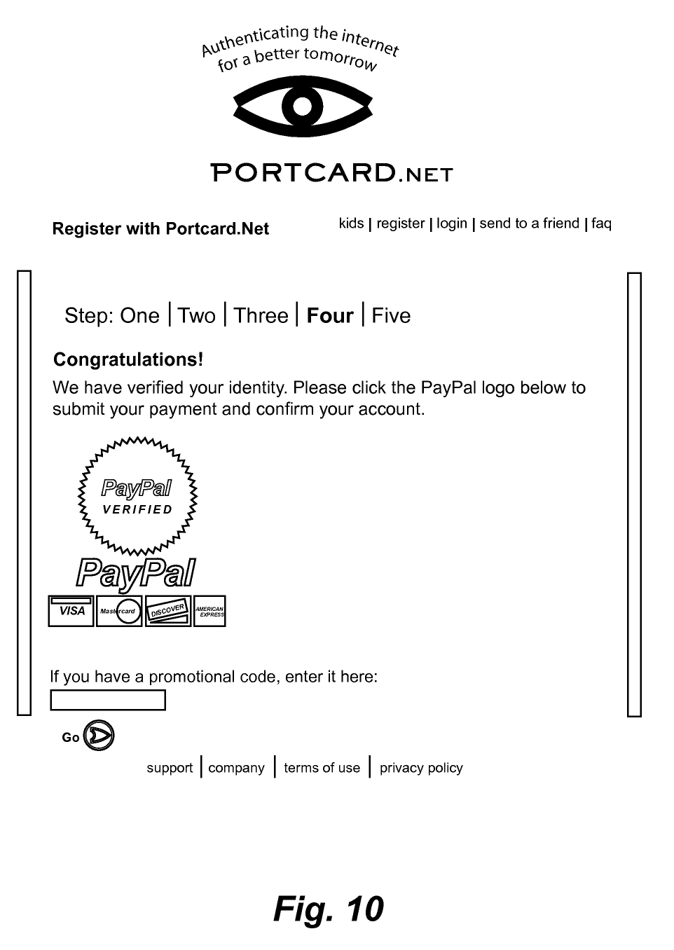

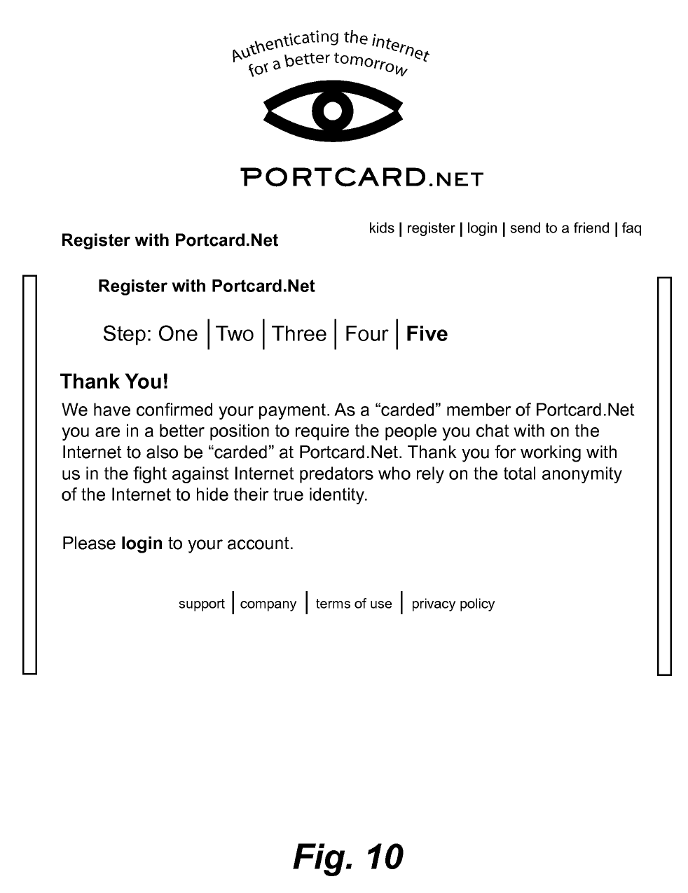

The registration process includes three steps. First, as depicted in FIG. 7, the person enters their email address, a password, and confirmation of the password. Second, as depicted in FIG. 8, system 10 collects basic identity information from the person, including first name, middle initial, last name, date of birth, last four digits of the social security numbers, address, city, state, zip code, phone number, prior address if at the first address less than one year, and optionally the drivers license number and state. Third, as depicted in FIG. 9, the person is verified through reporting agency server 20 by a series of challenge questions. If there is a negative result in response to a question during the series of questions, reporting agency server 20 informs the person that their identity cannot be verified, provides the person with an explanation, and provides the person with next steps to follow. If the series of questions yield a positive result, system 10 informs the person that they are verified, invites the person to register a child, if so provides an input form for entering the child's information (i.e., online identities and associated social networks), then as depicted in FIG. 10 allows the person to pay via PayPal, and then if payment is successful, as depicted in FIG. 10, acknowledges the payment and allows the person to login to their account.

In the login process, as depicted in FIG. 6, an authenticated user simply enters their email address and password provided during the registration process. If login is successful, the authenticated user directed to their account where they may 1) view, edit, and add attached networks and associated online identities, 2) change password, check status of and renew their subscription, 4) tell their friends about the system, and 5) review statistics regarding whether they have been carded (i.e., authentication attempts) by date and time.

From the above description, it will be apparent that the invention disclosed herein provides a novel and advantageous system and method for authenticating users in a social network. The foregoing discussion discloses and describes merely exemplary methods and embodiments of the present invention. One skilled in the art will readily recognize from such discussion that various changes, modifications and variations may be made therein without departing from the spirit and scope of the invention.

We claim:

1. A method for authenticating the identity of a person on a social network operating on the Internet, comprising the steps of:
obtaining identity information of a first person over a predetermined age;
comparing the identify information to information at a trusted identification server to authenticate the identity of the first person;
if authenticated, storing the identity information in a first database;
receiving from the first person at least one social network online identifier and associated social network of a second person under a predetermined age;
storing the online identifier in a second database;
receiving a request from a third person to verify the identity of a submitted online identifier;
determining if the submitted username is stored in the second database; and
if the submitted username is stored in the second database, transmitting to the third person a message confirming that the identity information of the second person associated with the submitted online identifier has been authenticated.

2. The method recited in claim 1, further comprising the step of:
providing the identity information of the second person to law enforcement in the event there is a safety concern involving the second person.

3. The method recited in claim 1, further comprising the steps of:
adding a widget to a social network page of the second person; and
allowing the third person to determine whether a friend request is from an authenticated person by accessing the second database by way of said widget.

4. The method recited in claim 1, further comprising the step of:
transmitting a series of challenge questions from the trusted identification server to the first person to verify the identity of the first person.

5. A method for authenticating the identity of a person on a social network operating on the Internet, comprising the steps of:
obtaining identity information of a first person;
comparing the identify information to information in a trusted identification server to authenticate the identity of the first person;
transmitting a series of challenge questions from the trusted identification server to the first person to verify the identity of the first person;
if the identity of the first person is verified, storing the identity information in a first database;
receiving from the first person at least one social network online identifier and associated social network;
storing the online identifier and associated social network in a second database;
receiving a request from a second person to verify the identity of a submitted online identifier;
determining if the submitted online identifier is stored in the second database; and
if the submitted username is stored in the second database, transmitting to the second person a message confirming that the identity information of the first person associated with the submitted online identifier has been authenticated.

6. The method recited in claim 1, further comprising the step of:
providing the identity information of the first person to law enforcement in the event there is a safety concern involving the second person.

7. The method recited in claim 1, further comprising the steps of:
adding a widget to a social network page of the first person; and
allowing the second person to determine whether a friend request is from an authenticated person by accessing the second database by way of said widget.

8. A system for authenticating the identity of a person on a social network operating on the Internet, comprising:
a server configured for serving web pages to user computers and in communication with a trusted identification server and at least one social network server;
a first database configured to store identity information; and
a second database configured to store online identifiers and associated social networks;
wherein the server is in communication with a user computer associated with a first person and configured to obtain identity information of a first person;
wherein the server transmits the identify information to the trusted identification server to authenticate the identity of the first person;
wherein the server receives from the trusted identification server and transmits to the user computer of the first person a series of challenge questions to verify the identity of the first person;
wherein if the identity of the first person is verified, the server causes the identity information to be stored in the first database;
wherein if the identity of the first person is verified, the server receives from the first person at least one social network online identifier and associated social network, and stores the online identifier and associated social network in the second database;
wherein the server in response to a received request from a second person to verify the identity of a submitted online identifier determines if the submitted online identifier is stored in the second database; and
wherein if the submitted username is stored in the second database, the server transmits to a user computer associated with the second person a message confirming that the identity information of the first person associated with the submitted online identifier has been authenticated.

9. The system recited in claim 1, wherein the server provides the identity information of the first person to law enforcement in the event there is a safety concern involving the second person.

10. The system recited in claim 1, wherein the server is configured to respond to a widget on a social network page of the first person, and allow the second person to determine whether a friend request is from an authenticated person by accessing the second database by way of said widget.
